(19) United States
(12) Patent Application Publication
(10) Pub. No.: US 2014/0013899 A1
(43) Pub. Date: Jan. 16, 2014

(54) CENTRIFUGAL PENDULUM DEVICE

(71) Applicant: Schaeffler Technologies AG & Co., KG, Herzogenaurach (DE)

(72) Inventors: Thorsten Krause, Buehl (DE); Eric Mueller, Kaiserslautern (DE)

(73) Assignee: Schaeffler Technologies AG & Co., KG, Herzogenaurach (DE)

(21) Appl. No.: 14/025,081

(22) Filed: Sep. 12, 2013

Related U.S. Application Data
(63) Continuation of application No. PCT/DE2012/000268, filed on Mar. 16, 2012.

(30) Foreign Application Priority Data
Mar. 31, 2011 (DE) 102011015632.1

(51) Int. Cl. F16F 15/315

(52) U.S. Cl. CPC F16F 15/315
USPC 74/574.2

(57) ABSTRACT

A centrifugal pendulum device having pendulum masses which are arranged axially on both sides of a pendulum mass carrier, which is rotatable about an axis of rotation. The pendulum masses form a pendulum mass pair, where the pendulum masses are connected to one another, to form the pendulum mass pair, by means of at least one fastening element, which is movable in a cutout in the pendulum mass carrier. The pendulum masses are pivotable relative to the pendulum mass carrier along a pendulum raceway by means of at least one rolling element, which can roll in each case one cutout in the pendulum mass carrier and in the pendulum masses. The at least two pendulum masses are arranged circumferentially adjacent to one another. The circumferential end region of one pendulum mass, and/or the fastening element, in a region situated axially within the cutout, and/or the cutout, has a bevel.

### CROSS-REFERENCE TO RELATED APPLICATIONS

This patent application is filed pursuant to 35 §120 and §365(c) as a continuation of International Patent Application No. PCT/DE2012/000268 filed Mar. 16, 2012, which application claims priority from German Patent Application No. 10 2011 015 632.1 filed Mar. 31, 2011, which applications are incorporated herein by reference in their entireties,

### FIELD OF THE INVENTION

The invention relates to a centrifugal pendulum device.

### BACKGROUND OF THE INVENTION

A centrifugal pendulum device for reducing torsional vibrations in a drivetrain of a motor vehicle is known from German Patent Application No. 10 2006 028 556 A1. The torsional vibrations can arise through the operation of a combustion engine and lead to unwanted noises, vibrations, and to failure of components. The centrifugal pendulum device has pendulum masses, which are arranged axially on both sides of a pendulum mass carrier which is rotatable about an axis of rotation and forms a pendulum mass pair due to the connection by means of a fastening element which reaches through a cutout in the pendulum mass carrier and is movable.

The pendulum masses are pivotable to a limited extent relative to the pendulum mass carrier along a pendulum raceway by means of at least one rolling element which is received and can roll in a recess in both the pendulum mass carrier and the pendulum mass while describing a deflection angle. Situated on the pendulum mass carrier is a plurality of pendulum masses circumferentially adjacent to each other, which are able to move relative to each other. Under certain conditions, the circumferentially adjacent pendulum masses can move in phase opposition, meaning relative to each other, and can also collide with each other, which can result in unwanted noises. The pendulum masses, for example, the fastening elements, can also bump into the respective cutouts of the pendulum mass carrier, and in so doing cause disturbing noises,

### BRIEF SUMMARY OF THE INVENTION

The object of the invention is to improve the sound formation of a centrifugal pendulum device, In addition, the reliability of the centrifugal pendulum device is to be increased.

Accordingly, a centrifugal pendulum device having pendulum masses, which are arranged axially on both sides of a pendulum mass carrier, which is rotatable about an axis of rotation and form a pendulum mass pair is proposed. The pendulum masses are connected to each other to form the pendulum mass pair by means of at least one fastening element, which is movable in a cutout in the pendulum MASS carrier and is pivotable to a limited extent relative to the pendulum mass carrier along a pendulum raceway by means of at least one rolling element, which is received and can roll in a recess in both the pendulum mass carrier and the pendulum masses, and where at least two pendulum masses are situated circumferentially adjacent to each other. Here, the circumferential end region of one pendulum mass, and/or the fastening element, in a region situated axially within the cutout, and/or the cutout, has a bevel. The noise development of a centrifugal pendulum device can be improved and reliability can also be increased.

In one embodiment, a first circumferential end region of a first pendulum mass and a second circumferential end region of a second circumferentially adjacent pendulum mass has such a bevel, so that the first and the second circumferential end regions can overlap axially when the pendulum masses approach each other.

In addition or alternatively, in an embodiment of the invention, the fastening element and the cutout each have complementary bevels, so that the fastening element and the cutout can overlap axially when they approach each other, For example, the fastening element has a conical shape due to the bevel.

In another embodiment, the axial overlapping can result in an axial offset of at least one pendulum mass and/or of the fastening element. For example, the axial offset can cause an axial relative motion of a pendulum mass in relation to the pendulum mass carrier. For example, the axial offset can result in an axial motion of both pendulum masses.

In yet another embodiment, the circumferential end region of at least one pendulum mass has a bevel, where the axial overlapping can result in an axial offset of at least one pendulum mass and where the axial offset causes a first pendulum mass to move axially toward the pendulum mass carrier and causes a second pendulum mass to move away from the pendulum mass carrier.

In another embodiment, the bevel is shaped so that a portrayable perpendicular to the plane of the bevel is warped and free of orthogonality to the axis of rotation.

The beveling of the circumferential end region of the pendulum mass can be produced by the process of stamping.

The centrifugal pendulum device can be situated on and/or in a hydrodynamic torque converter, on and/or in a clutch device, for example, a wet-running clutch, on and/or in a dual-clutch device, on a dual-mass flywheel or a torsional vibration damper.

### BRIEF DESCRIPTION OF THE DRAWINGS

The nature and mode of operation of the present invention will now be more fully described in the following detailed description of the invention taken with the accompanying drawing figures, in which:

FIG. 1 is a side view of a centrifugal pendulum device in special embodiment of the invention;

FIG. 2a is a detail of a three-dimensional view of a centrifugal pendulum device in an embodiment of the invention, in a first state;

FIG. 2b is the centrifugal pendulum device from FIG. 2a in a second state;

FIG. 2c is the centrifugal pendulum device from FIG. 2a in a third state;

FIG. 3a is a detail of a three-dimensional view of a centrifugal pendulum device in an embodiment of the invention, in a first state;

FIG. 3b is the centrifugal pendulum device from FIG. 3a in a second state; and,

FIG. 3c is the centrifugal pendulum device from. FIG. 3a in a third state.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs, Although any methods, devices or materials similar or equivalent to those described herein can be used in the practice or testing of the invention, the preferred methods, devices, and materials are now described.

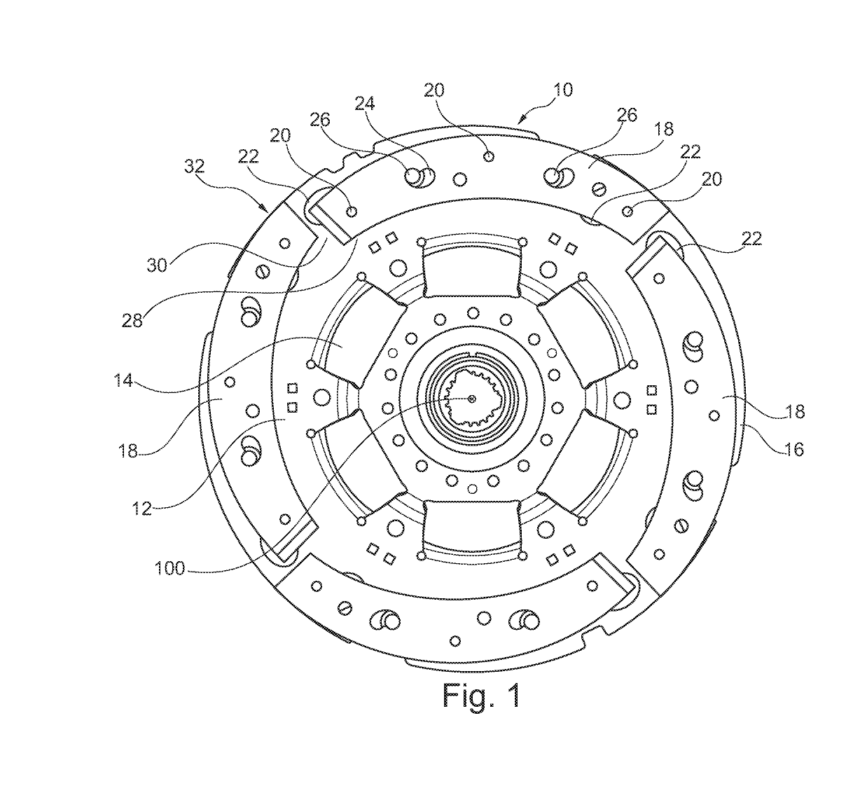

FIG. 1 shows a side view of a detail of centrifugal pendulum device 10 in an embodiment of the invention, Centrifugal pendulum device 10 is situated on damper component 12 of a torsional vibration damper, which damper component is rotatable about axis of rotation 100. Damper component 12 has, in a radially inner circumferential region, cutouts 14 to receive energy storage elements (not shown here), for example, coil springs, damper component 12 being rotatable to a limited extent relative to another damper component (not shown here) through the effect of these energy storage elements.

For example, the torsional vibration damper brings about a damping of torsional vibrations, which are caused by a combustion engine. The torsional vibration damper can be situated operationally in a drivetrain of a motor vehicle, between the combustion engine and a gear unit.

The radial elongation of damper component 12 forms pendulum mass carrier 16 to receive pendulum masses 18 situated on both sides of pendulum mass carrier 16. Two pendulum masses 18 in each case are joined together by means of a total of three fastening elements 20, for example, spacers, spacing bolts, rivets, clinch bolts, to form a pendulum mass pair. Fastening elements 20 are firmly connected to pendulum masses 18, for example, by riveting, and form in a region axially between pendulum masses 18 a section which reaches through cutouts 22 in pendulum mass carrier 16, cutouts 22 being kidney-shaped and formed in such away that they enable a motion of pendulum masses 18 relative to pendulum mass carrier 16 along a defined. pendulum raceway. The motion of pendulum masses 18 relative to pendulum mass carrier 16 can be either linear or linear in combination with a twisting of the pendulum mass pair around its pendulum mass center of gravity.

The pendulum raceway itself is defined b the contour of recesses 24 in pendulum masses 18 and complementary recesses in pendulum mass carrier 16, where in the here specifically kidney-shaped recesses 24 rolling elements 26, for example, rollers, are received, which can roll on recesses 24 to enable the pendulum mass pair to move along the pendulum raceway.

in circumferential end region 28 of pendulum mass 18, the latter has bevel 30, just as respective circumferentially adjacent pendulum mass 18 has in its adjacent circumferential end region 32 a complementary bevel (not visible here), so that when two pendulum masses 18 approach each other, an axial overlapping of two pendulum masses 18, for example, circumferential end regions 28, 32, can result, which can result in an axial offset of at least one pendulum mass 18, and thus, a retardation of the circumferential motion of pendulum mass 18.

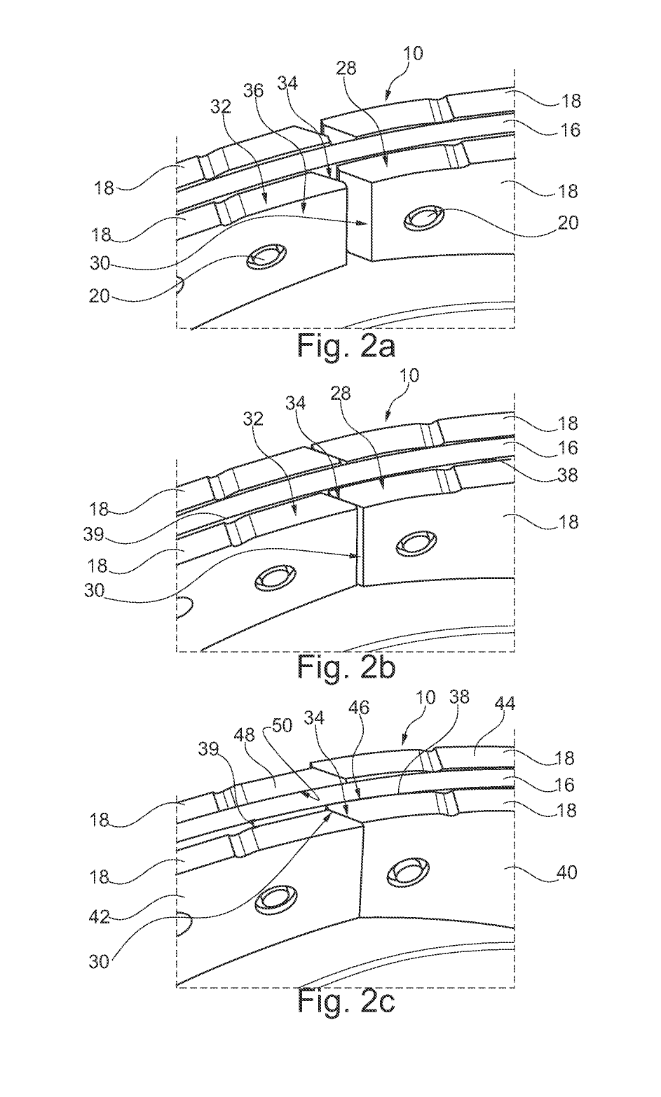

FIGS. 2a, 2b and 2c each show a detail of a three-dimensional view of centrifugal pendulum device 10 in an embodiment of the invention, each in a different state. The respective abutting circumferential end regions 28, 3′ of two circumferentially adjacent pendulum masses 18 each have a bevel 30, 34, the perpendicular 36 to a plane describing bevel 30 being warped and free of orthogonatlity to axis of rotation 100.

In FIG. 2a, two circumferentially adjacent pendulum masses 18 have approached each other, where two circumferential end regions 28, 32 with respective bevels 30, 34 overlap axially. When pendulum masses 18 approach more closely to each other, as depicted in a second state in FIG. 2b, circumferential end regions 28, 32 can touch with their bevels 30, 34, which can lead to a flat-area contact, the contact being limited for the most part to bevels 30, 34. Pendulum masses 18 each have first axial distance 38, 39 relative to pendulum mass carrier 16, which usually prevails during operation of centrifugal pendulum device 10 when pendulum masses 18 move along the pendulum raceway.

FIG. 2c shows centrifugal pendulum device 10 in a third state, in which pendulum masses 18 move further toward each other beyond the second state. Here, an axial offset of first pendulum mass 40 in relation to pendulum mass carrier 16, accompanied by a reduction of the axial distance between pendulum mass 40 and pendulum mass carrier 16 is caused by bevel 30 of first pendulum mass 40 and complementarily of second pendulum mass 42, and the circumferential relative motion, and where pendulum mass 40 can come to rest against pendulum mass carrier 16, where contact surface 46 can be formed between pendulum mass 40 and pendulum mass carrier 16, which can result in greater friction between pendulum mass 40 and pendulum mass carrier 16. That can result in a retardation of the motion of pendulum mass 40 relative to pendulum mass carrier 16.

While pendulum mass 40 can move toward pendulum mass carrier 16 in a first axial direction, combined with a reduction of axial distance 38 pendulum mass 42 can move in the opposite axial direction away from pendulum mass carrier 16, which is equivalent to an enlargement of axial distance 39. Here, respective pendulum mass partner 48 of pendulum mass 42, situated on the other axial side of pendulum mass carrier 16, comes into contact with the pendulum mass carrier on this axial side, contact surface 50.

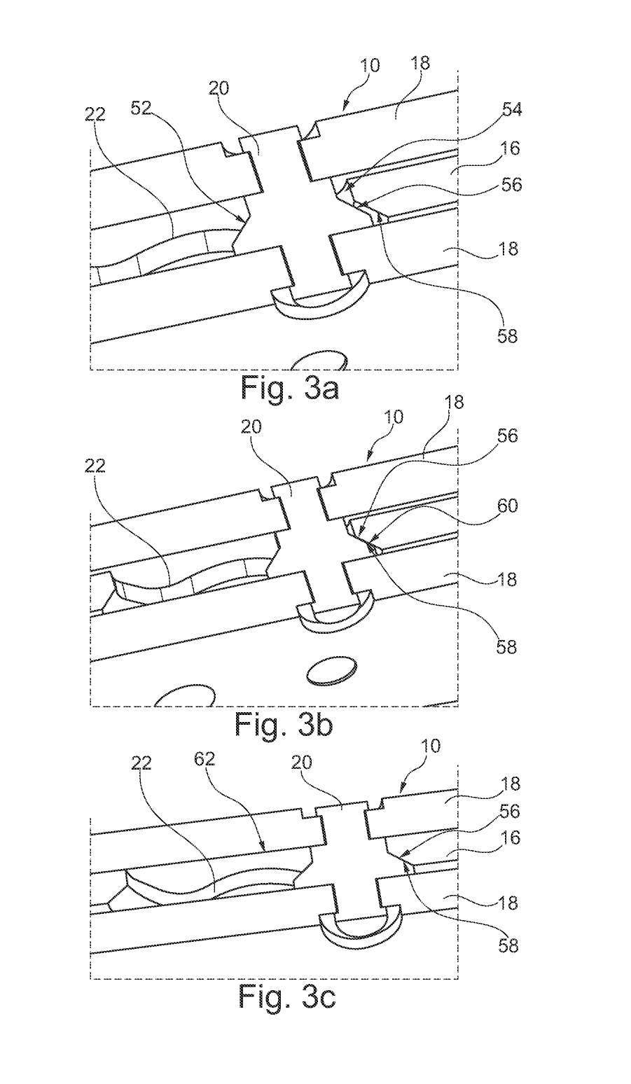

FIGS. 3a, 3b and 3c each show a detail of a three-dimensional view of centrifugal pendulum device 10 in an embodiment of the invention, each in a different state. Here, fastening element 20 has region 52 located within cutout 22 in pendulum mass carrier 16, to join two pendulum masses 18 situated axially on pendulum mass carrier 16 opposite each other to form a pendulum mass pair. Region 52 is subdivided into cylindrical region 54 and an axial adjacent region having bevel 56, designed in particular as a conical region. Complementary to bevel 56 on fastening element 20, on cutout 22 axial region 58 running around cutout 22 is beveled off, so that when fastening element 20 approaches cutout 22 two bevels 56, 58 are able to overlap axially.

When fastening element 20 approaches closer to cutout 22, fastening element 20 can come to rest on cutout 22, as shown in FIG. 2b in a second state of centrifugal pendulum device 10, forming mating surface 60, which is formed essentially by bevels 56, 58 on fastening element 20 and on cutout 22.

As fastening element 20 moves further relative to cutout 22 of pendulum mass carrier 16, the relative motion is converted by bevel 56 on fastening element 20 and by bevel 58 on cutout 22 into an axial motion of fastening element 20 relative to cutout 22, and thus, to pendulum mass carrier 16, while pendulum mass 18 can come into contact with pendulum mass carrier 16, forming contact surface 62. The associated increase of the friction force between pendulum mass 18 and pendulum mass carrier 16 causes a retardation of the relative motion between pendulum mass 18 and pendulum mass carrier 16, and thus, a reduction of the noise development when fastening element 20 hits cutout 22.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present. invention.

### LIST OF REFERENCE NUMBERS

10 centrifugal pendulum device
12 damper component
14 cutout
16 pendulum mass carrier
18 pendulum mass
20 fastening element
22 cutout
24 recess
26 rolling element
28 end region
30 bevel
32 end region
34 bevel
36 perpendicular
38 distance
39 distance
40 pendulum mass
42 pendulum mass
48 pendulum mass partner
50 contact surface
52 region
54 region
56 bevel
58 region
60 mating surface
62 contact surface
100 axis of rotation

What is claimed is:

1. A centrifugal pendulum device, comprising:
pendulum masses which are arranged axially on both sides of a pendulum mass carrier which is rotatable about an axis of rotation and form a pendulum mass pair, where the pendulum masses are connected to each other to form the pendulum mass pair by means of at least one fastening element which is movable in a cutout in the pendulum mass carrier and are pivotable to a limited extent relative to the pendulum mass carrier along a pendulum raceway by means of at least one rolling element which can roll in a recess in both the pendulum mass carrier and the pendulum masses, and where at least two pendulum masses are situated circumferentially adjacent to each other, wherein the circumferential end region of a pendulum mass and/or the fastening element in a region situated axially within the cutout and/or the cutout has a bevel.

2. The centrifugal pendulum device as recited in claim 1, wherein a first circumferential end region of a first pendulum mass and a second circumferential end region of a second circumferentially adjacent pendulum mass have such a bevel, so that the first and the second circumferential end regions can overlap axially when the pendulum masses approach each other.

3. The centrifugal pendulum device as recited in claim 2, wherein the fastening element and the cutout each have complementary bevels, so that the fastening element and the cutout can overlap axially when they approach each other.

4. The centrifugal pendulum device as recited in claim 1, wherein the fastening element has a conical form in some sections due to the bevel.

5. The centrifugal pendulum device as recited in claim 2, wherein the axial overlap can cause an axial offset of at least one pendulum mass and/or of the fastening element.

6. The centrifugal pendulum device as recited in claim 5, wherein the axial offset can cause an axial relative motion of a pendulum mass in relation to the pendulum mass carrier.

7. The centrifugal pendulum device as recited in claim 5, wherein the axial offset can result in an axial motion of both pendulum masses,

8. The centrifugal pendulum device as recited in claim 1, wherein the circumferential end. region of a pendulum mass has a bevel and the axial overlap can result in an axial offset of at least one pendulum mass, and where the axial offset causes a first pendulum mass to move axially toward the pendulum mass carrier and causes a second pendulum mass to move away from the pendulum mass carrier.

9. centrifugal pendulum device as recited in claim 1, wherein the bevel is shaped so that portrayable perpendicular to the plane of the bevel is warped and free of orthogonality to the axis of rotation.

10. The centrifugal pendulum device as recited in claim 1, wherein the bevel of the circumferential end region of the pendulum mass is producible by the process of stamping.
